(19) United States
(12) Patent Application Publication
(10) Pub. No.: US 2024/0269794 A1
(43) Pub. Date: Aug. 15, 2024

(54) Working head for a machine tool having an interchangeable electrospindle

(71) Applicant: HPT Sinergy S.r.l., Padova (PD) (IT)

(72) Inventor: Gabriele Piccolo, Camposanpiero (PD) (IT)

(21) Appl. No.: 18/290,773

(22) PCT Filed: Jul. 27, 2022
(86) PCT No.: PCT/IB2022/056928

§ 371 Date: Jan. 20, 2024

(30) Foreign Application Priority Data
Jul. 28, 2021 (IT) 102021000020099

(51) Int. Cl. B23Q 37/00; B23Q 5/10

(52) U.S. Cl. CPC B23Q 37/002; B23Q 5/10

(57) ABSTRACT

A working head for a machine tool with non-orthogonal axes, with a support movable along three Cartesian axes, includes a first body mounted to the support to rotate about a first polar axis parallel to one of the Cartesian axes, a second body mounted to the first body to rotate about a second polar axis tilted at a predetermined first angle from the first polar axis, a tool holder electrospindle designed to be coupled to the second body, and an automatic connection system of the electrospindle to the second body. The connection system includes a plurality of pins, which can selectively fit into corresponding seats on the second body or on the electrospindle for centering and locking. Each seat has a collet that is shaped and selectively movable along its axis to exert a radial locking/unlocking action on the pin. A method of locking/unlocking an electrospindle to/from a working head.

### TECHNICAL FIELD

The present invention generally finds application in the field automatic machine tools with interpolated axes and particularly relates to a working head for a machine tool with non-orthogonal axes.

The invention also relates to a method of locking/unlocking an electrospindle to/from such working head.

### BACKGROUND ART

Automatic machine tools have been long known to use working heads applied to the bottom end of a support moving along Cartesian axes.

Generally, orthogonal or non-orthogonal machines have been used for material-removal machining of mechanical workpieces.

In a non-orthogonal machine tool, the working head comprises a first body mounted to the support that rotatably moves about a first polar axis parallel to one of the three axes and a second body mounted to the first body and rotating about a second polar axis, which is tilted from the first.

The tilt between the first and second bodies of the working head allows a tool holder electrospindle coupled to the second body to decrease the distance of the tool from the work surface. In addition, due to this tilt the working head can have a smaller footprint, and operate in undercut conditions.

In this type of machine tools, the electrospindle is generally rigidly joined to the second body and the tool is interchangeable to allow different types of material removal tasks to be carried out on the workpiece.

Nevertheless, the structure and characteristics of the electrospindle should vary to a considerable extent from rough machining, with a tool rotating about the spindle axis at a relatively low speed and removing large amounts of material, to finishing work with a tool rotating at high speeds and removing small amounts of material.

Therefore, in order to avoid full head replacement, systems for locking/unlocking the electrospindle to/from the second body have been developed, which use automatic connection means for easier electrospindle replacement as the working conditions of the machine change.

EP1205275 discloses an operating head for an automatic machine tool as discussed above, which has an interchangeable electrospindle and can be positioned at an angle about the axis of the second body.

In particular, this known head includes means for connecting the electrospindle to the second body, which consist of a series of clamps designed to selectively engage corresponding shanks rigidly joined to the support of the electrospindle.

In addition, a system is provided on the coupling surface of the electrospindle and the second body, which is designed to compress a fluid to deform an elastic wall that is designed to frictionally lock the electrospindle to the second body.

A first drawback of this known arrangement is that the connection means are not able to safely ensure the locking/unlocking effect of the electrospindle to the head, which may lead to electrospindle positioning errors and/or cause the electrospindle to be locked throughout the working time.

Furthermore, the use of a wall designed to be deformed by pressurized liquid dramatically limits the durability of the deformable wall, thus increasing the maintenance costs of electrospindles and the head.

Yet another drawback of this arrangement is that the connection means limit the rate of change of the electrospindle and are highly complex.

Therefore, this arrangement does not ensure appropriate interchangeability of the electrospindle and turns out to be unpractical.

### Technical Problem

In light of the prior art, the technical problem addressed by the present invention is to facilitate the interchangeability of an electrospindle on a working head of a non-orthogonal machine tool and to increase safety during centering and locking/unlocking the electrospindle on the head.

### DISCLOSURE OF THE INVENTION

The object of the present invention is to obviate the above drawback, by providing a working head for a machine tool with non-orthogonal axes that is highly efficient and cost-effective.

A particular object of the present invention is to provide a working head as discussed above that affords interchangeability of an electrospindle in a repeatable manner over time and with increased safety during centering and locking of the electrospindle on the head.

A further object of the present invention is to provide a working head as discussed above, that can exert a high clamping force and afford accurate positioning of the electrospindle.

Another object of the present invention is to provide a working head as discussed above that can avoid any undesired unlocking of the electrospindle from its operating position, as a result of workpiece machining vibration.

Yet another object of the present invention is to provide a working head as discussed above that is versatile and can be used to ensure interchangeability of electrospindles of different weights and sizes.

A further object the present invention is to provide a working head as discussed above that can operate with commercial, commonly available connection means.

Another object of the present invention is to provide a working head as discussed above that has a small size.

These and other objects, as more clearly explained hereinafter, are fulfilled by a working head for a machine tool having non-orthogonal axes which is equipped with a support moving along three perpendicular axes, as defined in the accompanying claim 1.

The head comprises a first body that is mounted to the support to rotate about a first polar axis parallel to one of said three axes, a second body mounted to the first body to rotate about a second polar axis tilted at a predetermined first angle from the first axis and a tool holder electrospindle that can be coupled to the second body along a coupling surface.

Automatic means for connection of the electrospindle to the second body are also provided, which comprise a plurality of pins mounted to the electrospindle or the second body, that can selectively fit into corresponding seats on the second body or on the electrospindle for mutual centering and locking, with each seat comprising a suitably shaped collet selectively movable along its axis to exert a radial locking/unlocking action on the pin.

Particularly, the pins and the seats are positioned at the vertices of a rectangle.

Each seat comprises a central element inserted inside the collet and has a recess for housing a corresponding pin and an outer cylindrical surface for guiding the axial movement of the collet.

In addition, each seat comprises a number of counteracting members designed to be accommodated in corresponding angularly offset holes formed on the central element, with each counteracting member being designed to interact with the inner surface of the collet.

With this combination of features, the working head affords interchangeability of the electrospindle in a repeatable manner over time as well as safe centering and locking thereof.

The invention also relates to a method of locking/unlocking an electrospindle to/from a working head as defined in claim 15.

Advantageous embodiments of the invention are as defined in the dependent claims.

### BRIEF DESCRIPTION OF THE DRAWINGS

Further characteristics and advantages of the invention will be more apparent upon reading of the detailed description of a preferred, non-exclusive embodiment of a working head for a machine tool with non-orthogonal axes as discussed above, as shown by way of a non-limiting example with the help of the following drawings, in which:

FIGS. 1 and 2 are side views of a working head of the invention in first and second operating configurations respectively;

FIGS. 3 and 4 are perspective views of the working head of FIG. 1 with enlargements of first and second detail respectively;

FIGS. 5 and 6 are front views of the working head of FIG. 1 with an enlarged section of the first detail of FIG. 3 and the second detail of FIG. 4 respectively;

FIG. 7 is a broken-away view of the connection means of the working head of FIG. 1;

FIG. 8 is an enlarged view of FIG. 7.

### DETAILED DESCRIPTION OF A PREFERRED EXEMPLARY EMBODIMENT

Particularly referring to the above figures, there is shown a working head, generally designated by numeral 1, for a machine tool with non-orthogonal axes, having a support moving along three Cartesian axes X, Y, Z perpendicular to each other.

By way of example and without limitation, the machine tool may be used in the field of material-removal machining of semi-finished products or mechanical workpieces, generally made of metal.

The machine tool, not shown, may comprise a load-bearing structure consisting, for example, of a pair of vertical posts or walls on which a beam or longitudinal column is slidingly mounted, for supporting and guiding the head 1 by means of the support, also not shown, along the Cartesian axes X, Y perpendicular to each other and lying in a horizontal plane.

The support may comprise substantially vertical driving means, not shown, which can be coupled to the beam or column of the machine tool to move the head 1 along the vertical axis Z.

The head 1 comprises a first body 2 rotatably mounted to the support and rotating about a first polar axis A parallel to one of the three axes X, Y, Z.

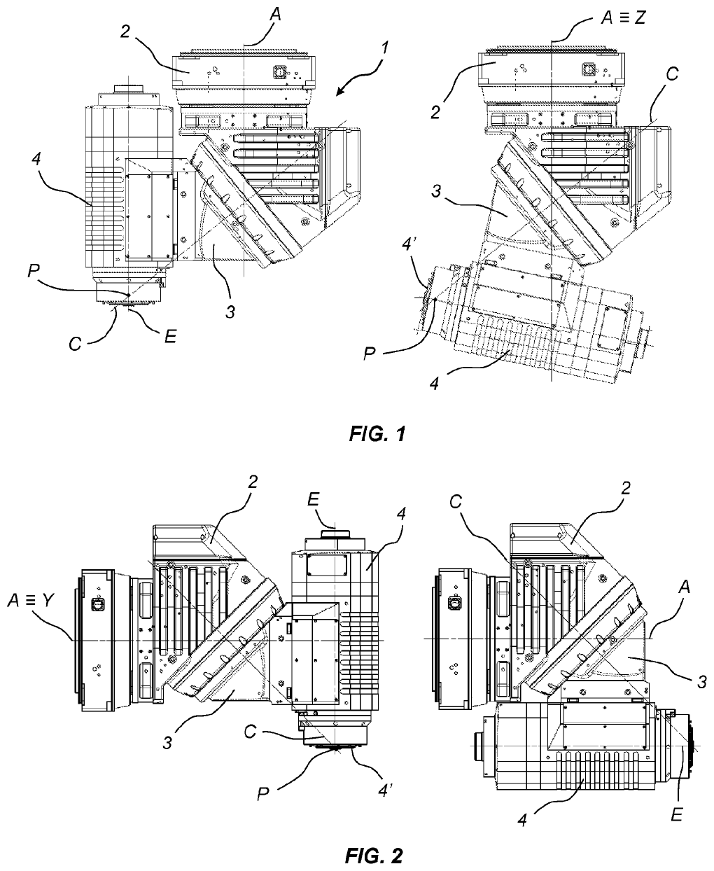

In a well-known manner, the first polar axis A is parallel to the vertical axis Z in vertical machine tools, as shown in FIG. 1, or parallel to the horizontal axis X or the horizontal axis Y in horizontal machine tools, as shown in FIG. 2.

The head 1 comprises a second body 3 rotatably mounted to the first body 2 and rotating about a second polar axis C which is tilted at a predetermined first angle α from the first polar axis A.

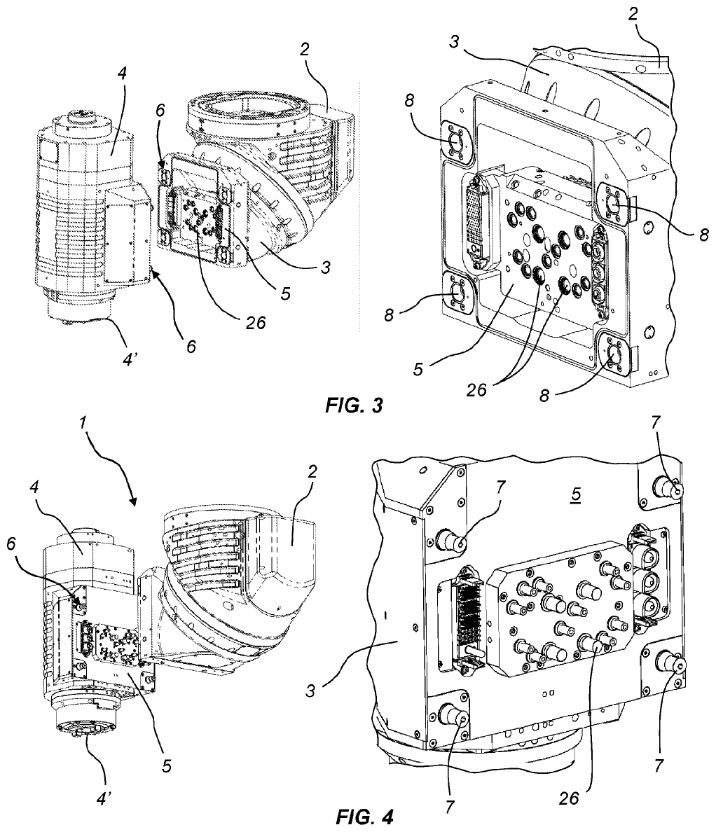

As best shown in FIGS. 1 to 4, the head 1 comprises a tool holder electrospindle 4 that is designed to be coupled to the second body 3 along a coupling surface 5.

In the embodiment of the figures, the first predetermined angle α ranges from 45° to 52°, and the coupling surface 5 is tilted at a second predetermined angle β from the second polar axis C that ranges from 10° to 25°, for the working head 1 to be able to work in undercut conditions, as shown in FIG. 1.

In addition, the electrospindle 4 has a front end surface 4′ with a working tool U clamped thereon and comprises a rotation axis E of the tool U, preferably parallel to the coupling surface 5.

In a preferred embodiment of the invention, the rotation axis E of the working tool U intersects the second polar axis C at a predetermined point P of the rotation axis E.

A peculiar feature is that the distance between the point P and the front end surface 4′, commonly known as “pivot” distance, ranges from 0 to 50 mm, and is preferably about 20 mm.

Thus, the electrospindle 4 can be moved along the Cartesian axes X, Y, Z and about the polar axes A, C while keeping the tip of the working tool U essentially fixed at the working point.

Furthermore, such a small pivot distance allows the working head 1 of the invention to maximize the utilization of the working field given by the travels along the three Cartesian axes X, Y, Z of the machine tool, thereby increasing the allowable maximum dimensions of the workpiece.

In addition, automatic means 6 are provided for connection of the electrospindle 4 to the second body 3 to allow the electrospindle 4 to be automatically removed from the second body 3 and replaced by a different electrospindle 4 for a type of machining process other than the former.

For example, the electrospindle 4 may be used for rough machining, using a working tool U that rotates about the spindle axis E at a relatively low speed and removing large amounts of material.

On the other hand, the other electrospindle 4 may be used for finishing work using a different working tool U that rotates about the spindle axis at high speeds and removing small amounts of material.

Advantageously, the connection means 6 comprise a plurality of pins 7 mounted to the electrospindle 4 or the second body 3 which can selectively fit into corresponding seats 8 on the second body 3 or the electrospindle 4 for mutual centering and locking.

According to the invention, four pins 7 and four seats 8 are provided, arranged at the vertices of a rectangle.

In addition, each seat 8 comprises a collet 9 which is suitably shaped and selectively movable along its axis 10 to exert a radial locking/unlocking force on the pin 7, as further described below.

Each seat 8 comprises a central element 11 inserted inside the collet 9, having a recess 12 for housing a corresponding pin 7 and an outer cylindrical surface 13 for guiding the axial movement of the collet 9.

Conveniently, the collet 9 has a substantially cylindrical shape with an inner surface 14 having a minimum inside diameter greater than the outside diameter of the outer cylindrical surface 13 and a longitudinal end having a substantially conical surface 15 with a predetermined taper angle δ with respect to the axis 10 of the collet 9.

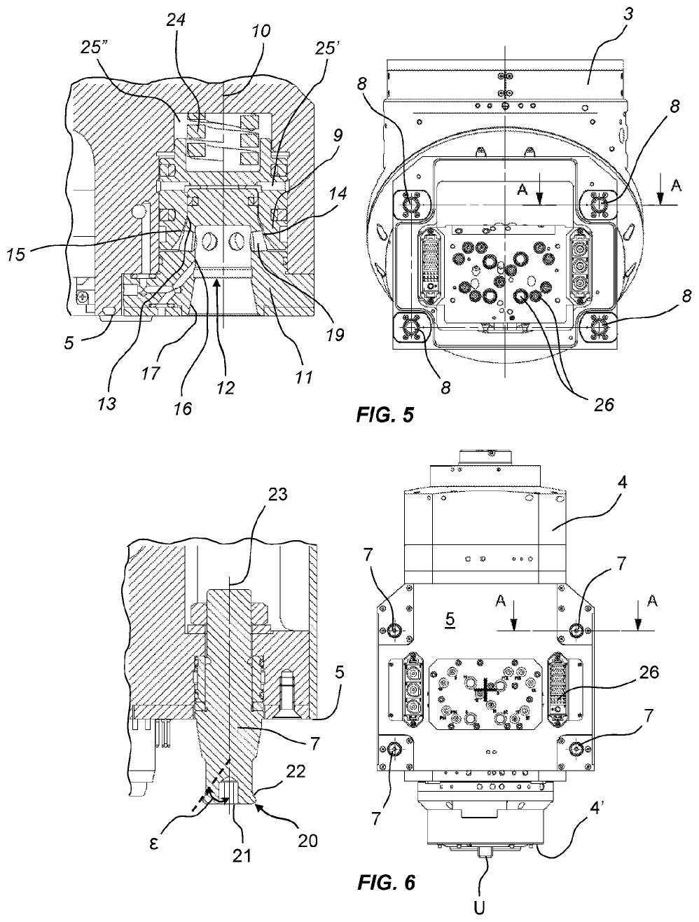

As best shown in FIGS. 5, 7 and 8, the central element 11 is essentially tubular and comprises a substantially cylindrical wall 16 designed to define a recess 12 having a conical flared end portion 17.

Advantageously, each seat 8 comprises a series of counteracting members 18 designed to be accommodated in corresponding angularly offset holes 19 formed at an intermediate portion of the central element 11 along an annular peripheral area.

In the embodiment as shown in FIG. 8, the counteracting members 18 have a spherical shape and are slidingly introduced with a precision running fit into complementarily shaped holes 19 defining substantially radial sliding guides.

In an alternative embodiment, not shown, the counteracting members 18 may also have a shape other than the spherical shape, although this is less effective, such as a prismatic or another appropriate shape.

As shown in FIGS. 6, 7 and 8, each pin 7 comprises an expanded end 20 with a flat front surface 21 and an annular rear surface 22 tilted at a predetermined tilt angle ε from the axis 23 of the pin 7 to cooperate with the series of counteracting members 18.

Thus, each counteracting member 18 is capable of interacting with both the inner surface 14 of the collet 9 and the expanded end 20 of the corresponding pin 7. Namely, each counteracting member 18 interacts with the substantially conical surface 15 and the annular rear surface 22 during the axial movement of the collet 9.

In other words, as a result of the axial movement of the collet 9 along the outer cylindrical surface 13 of the central element 11, the rear surface 22 of the pin 7 and the substantially conical surface 15 of the collet 9 interact to radially push each counteracting member 18 and exert an axial clamping force on the pin 7.

Of course, the rear surface 22 of the pin 7 and the conical surface 15 of the collet 9 are suitably shaped to complement the shape of the counteracting members 18, whether the latter have a spherical or a substantially prismatic shape.

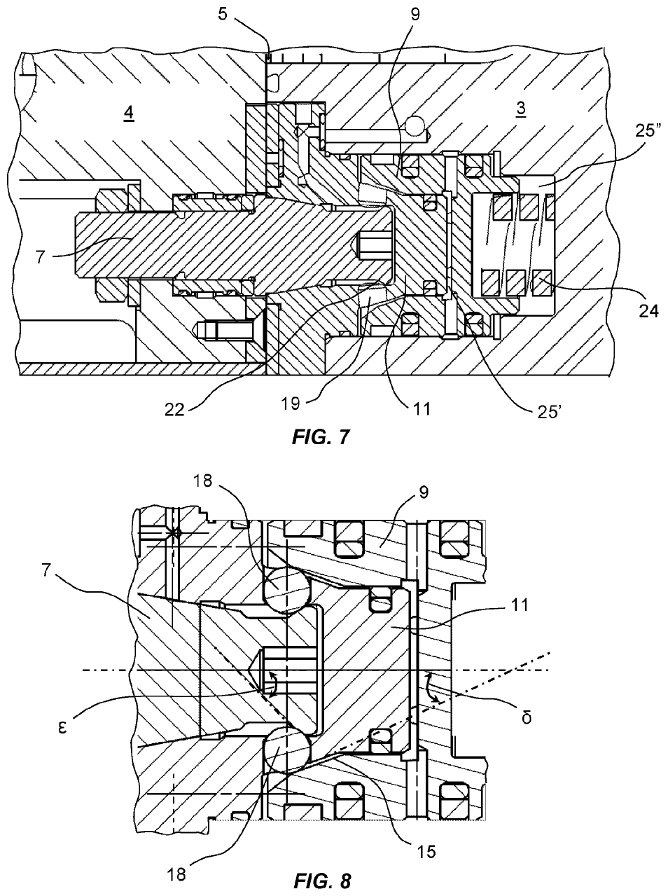

As shown in FIGS. 5 and 7, axial thrust means 24 are provided to push each collet 9 from an idle end position in which it does not interact with the series of counteracting members 18 to an operating closed end position in which the collet 9 radially pushes the counteracting members 18 toward the pin 7.

Preferably, the axial thrust means 24 are selected from the group comprising hydraulic or spring means. In the configuration with hydraulic axial thrust means 24, at least two thrust chambers 25′, 25″ are provided between the bottom of the seat 8 and the collet 9.

The thrust chambers 25′, 25″ are capable of being alternately filled with a fluid to selectively drive the axial thrust means 24 and move the collet 9 from the idle end position to the operating closed end position and vice versa and then from an unlocked state to a locked state of the pins 7 and vice versa.

Thus, even when no force is applied to the axial thrust means 24, the collet 9 remains in the position in which it locks the corresponding pin 7 to prevent undesired unlocking due, for example, to high vibration during workpiece machining.

It will be understood that, due to the tilt of the conical surface 15 with the taper angle δ and the rear surface 22 with the tilt angle ε, the counteracting members 18 exert an axial clamping force on the pin 7 which ensures that the electrospindle 4 will be locked to the second body 3 of the head 1 with high stability.

This is because the taper angle δ of the conical surface 15 is different from the tilt angle ε of the rear surface 22, as shown in FIGS. 7 and 8.

Namely, the taper angle δ of the conical surface 15 is less than the tilt angle ε of the rear surface 22, to prevent any pin 7 from slipping off its seat 8 when the collet 9 is in the operating closed position, thereby increasing its safety.

Conveniently, the connection means 6 also comprise a series of electromechanical connections 26 which are designed to provide electrical power and signal supply to the rotation means of the working tool U of the electrospindle 4, fluid supply to the axial thrust means 24, as well as any coolant supply to the working tool U.

According to a further particular aspect, the invention provides a method of locking an interchangeable electrospindle 4 as described above, which includes the steps of:
providing a working head 1 having an electrospindle 4 as described above;
fitting the plurality of pins 7 into the corresponding seats 8;
automatically actuating the connection means 6, and moving the collet 9 along its axis 10 by means of the thrust means 24 to push the collet 9 toward the pin 7;
pushing the counteracting members 18 toward the pin 7 via the collet 9 to move it from an idle initial position in which it does not interact with the series of counteracting members 18 to an operating closed position in which the collet 9 radially pushes the series of counteracting members 18 and locks the electrospindle 4 to the second body 3 of the head 1.

In particular, the counteracting members 18 interact with the substantially conical surface 15 of the collet 9 and with the rear surface 22 of the pin 7. In addition, the taper angle δ of the conical surface 15 is other than the tilt angle ε of the rear surface 22.

Now, the electrospindle 4 is coupled to the second body 3 of head 1 and the working tool U may be operated for a first machining process.

The method of the invention also comprises the following steps to unlock the electrospindle 4 from the head 1:
automatically actuating the connection means 6, and moving the collet 9 along its axis 10 by means of the thrust means 24 to push the collet 9 toward the bottom of the seat 8;
pushing the counteracting members 18 toward the collet 9 by releasing the pin 7 to move the collet 9 from the operating closed position in which the collet 9 radially pushes the series of counteracting members 18 to an idle initial position in which the collet 9 does not interact with the series of counteracting members 18 and unlocks the electrospindle 4 from the second body 3 of the head 1.

Now the electrospindle 4 is uncoupled from the second body 3 of the head 1 and is ready for coupling to an electrospindle other than the previous electrospindle 4 for a second machining task, other than the former.

It will be appreciated from the above that the working head and the locking/unlocking method of the invention fulfill the intended objects and specifically ensure repeatability over time and increased safety during centering and locking of the electrospindle on the head.

The head and method of the invention are susceptible to a number of changes or variants, within the inventive concept disclosed in the appended claims.

While the head and method have been described with particular reference to the accompanying figures, the numerals referred to in the disclosure and claims are only used for the sake of a better intelligibility of the invention and shall not be intended to limit the claimed scope in any manner.

Reference herein to “one embodiment” or “the embodiment” or “some embodiments” indicates that a particular characteristic, structure or element that is being described is included in at least one embodiment of the inventive subject matter.

Furthermore, the particular characteristics, structures or elements may be combined together in any suitable manner to provide one or more embodiments.

### INDUSTRIAL APPLICABILITY

The present invention may find application in industry, because it can be produced on an industrial scale in factories for manufacturing non-orthogonal machine tools.

The invention claimed is:

1. A working head (1) for machine tools with non-orthogonal axes, wherein the machine comprises a support adapted to move along three Cartesian axes (X, Y, Z), the working head (1) comprising:
a first body (2) configured to be mounted to the support to rotate about a first polar axis (A) parallel to one of said three Cartesian axes (X, Y, Z);
a second body (3) rotatably mounted to said first body (2) and rotating about a second polar axis (C), which is tilted at a predetermined first angle (α) from said first polar axis (A);
a tool holder electrospindle (4) configured to be coupled to said second body (3) along a coupling surface (5); and
automatic connection means (6) for connecting said electrospindle (4) to said second body (3);
wherein said automatic connection means (6) comprise a plurality of pins (7) mounted to said electrospindle (4) or to said second body (3), which can selectively fit into corresponding seats (8) on said second body (3) or on said electrospindle (4) for a mutual centering and locking;
wherein said pins (7) and said seats (8) are positioned at vertices of a rectangle; and
wherein each seat (8) comprises a collet (9) that is configured and selectively movable along an axis (10) of the collet to exert a locking/unlocking action on one of said pins (7).

2. The working head as claimed in claim 1, wherein each seat (8) comprises a central element (11) inserted inside said collet (9), said central element (11) having a recess (12) for housing a corresponding pin (7) and an outer cylindrical surface (13) for guiding an axial movement of said collet (9).

3. The working head as claimed in claim 2, wherein each seat (8) comprises a series of counteracting members (18) configured to be accommodated in corresponding angularly offset holes (19) formed on said central element (11), each of said counteracting members (18) being designed to interact with an inner surface (14) of said collet (9).

4. The working head as claimed in claim 3, further comprising axial thrust means (24) that push each collet (9) from an idle initial position, in which the collet does not interact with the series of counteracting members, (18) to an operating closed position, in which the collet interacts and radially pushes said series of counteracting members (18).

5. The working head as claimed in claim 3, wherein said collet (9) has the inner surface (14) with a surface of conical shape (15) with a predetermined taper angle (δ) at one longitudinal end adapted to interact with said series of counteracting members (18).

6. The working head as claimed in claim 3, wherein each pin (7) comprises an expanded end (20) with a flat front surface (21) and an annular rear surface (22) tilted at a predetermined tilt angle (ε) from an axis (23) of the pin (7) to cooperate with said series of counteracting members (18).

7. The working head as claimed in claim 5, wherein each pin (7) comprises an expanded end (20) with a flat front surface (21) and an annular rear surface (22) tilted at a predetermined tilt angle (ε) from an axis (23) of the pin (7) to cooperate with said series of counteracting members (18), and wherein said taper angle (δ) differs from said tilt angle (ε).

8. The working head as claimed in claim 5, wherein each pin (7) comprises an expanded end (20) with a flat front surface (21) and an annular rear surface (22) tilted at a predetermined tilt angle (ε) from an axis (23) of the pin (7) to cooperate with said series of counteracting members (18), and wherein said taper angle (δ) is less than said tilt angle (ε) to prevent any pin (7) from slipping off its seat (8) when said collet (9) it is in this operating closed position.

9. The working head as claimed in claim 8, wherein each counteracting member (18) has a spherical shape designed to interact with said expanded end (20) of a corresponding pin (7).

10. The working head as claimed in claim 1, wherein said electrospindle (4) has a rotation axis (E) of a working tool (U) clamped thereon, said a rotation axis (E) being parallel to said coupling surface (5).

11. The working head as claimed in claim 10, wherein said electrospindle (4) has a front end surface (4′) with the working tool (U) clamped thereon, said rotation axis (E) intersecting said second polar axis (C) at a predetermined point (P) of said rotation axis (E), a distance between said predetermined point (P) and said front end surface (4′) ranging from 0 to 50 mm.

12. The working head as claimed in claim 1, wherein said first polar axis (A) is parallel to one of the three Cartesian axes (X, Y) that is horizontal in horizontal machine tools or to a one of the three Cartesian axes (Z) that is vertical in vertical machine tools.

13. The working head as claimed in claim 1, wherein said first predetermined angle (α) ranges from 45° to 52°.

14. The working head as claimed in claim 1, wherein said coupling surface (5) is tilted at a predetermined second angle (β) from said second polar axis (C) which ranges from 10° to 25°.

15. A method of locking/unlocking an electrospindle (4) to a working head (1), comprising the steps of:
providing a working head (1) having an electrospindle (4) as claimed in claim 4;
fitting said plurality of pins (7) into the corresponding seats (8);
actuating said connection means (6) and moving said collet (9) along the axis (10) thereof via said thrust means (24);
wherein said pins (7) and said seats (8) are positioned at the vertices of the rectangle;
wherein said collet (9) is pushed toward the corresponding pin (7) to move said collet (9) from said idle initial position to said operating closed position and to lock said electrospindle (4) to said second body (3);
wherein said collet (9) is pushed toward the corresponding seat (8) to move said collet (9) from said operating closed position to said idle initial position and to unlock said electrospindle (4) from said second body (3);
wherein said collet (9) has the inner surface (14) with a conical surface (15) with a predetermined taper angle (δ) at one longitudinal end adapted to interact with said series of counteracting members (18);
wherein each pin (7) comprises an expanded end (20) with a flat front surface (21) and an annular rear surface (22) tilted at a predetermined tilt angle (ε) from an axis (23) of the pin (7) to cooperate with said series of counteracting members (18);
wherein said counteracting members (18) interact with said conical surface (15) of the collet (9) and with said rear surface (22) of said pin (7), and
wherein said predetermined taper angle (δ) of said conical surface (15) differs from said tilt angle (ε) of said rear surface (22).
